(19) United States
(12) Patent Application Publication
(10) Pub. No.: US 2026/0356113 A1
(43) Pub. Date: Nov. 12, 2026

(54) SHEET CONVEYANCE APPARATUS, IMAGE FORMING APPARATUS, AND IMAGE FORMING SYSTEM

(71) Applicant: CANON KABUSHIKI KAISHA, Tokyo (JP)

(72) Inventor: HIDEKAZU TAKAHASHI, Chiba (JP)

(21) Appl. No.: 19/673,943

(22) Filed: May 11, 2026

(30) Foreign Application Priority Data
May 12, 2025 (JP) 2025-079448

(51) Int. Cl. B41J 13/32; B41J 13/00

(52) U.S. Cl. CPC B41J 13/32; B41J 13/0018

(57) ABSTRACT

A sheet conveyance apparatus includes a conveyance unit, a first roller pair, a switching mechanism, a first conveyance driving unit, a first turn driving unit, a first turning support, and a control unit. The switching mechanism switches between a contact state in which a first driven roller and a first driving roller are brought into contact with each other, and a separated state in which the first driven roller and the first driving roller are separated from each other. The control unit executes a first operation of bringing the switching mechanism into the contact state and rotate the first driving roller by the first conveyance driving unit before a leading edge of the sheet conveyed by the conveyance unit reaches the first roller pair, so that the first driven roller is turned to follow the first driving roller while being driven by the first driving roller.

### BACKGROUND

### Field of the Technology

The present disclosure relates to a sheet conveyance apparatus, an image forming apparatus, and an image forming system that correct skew feeding of a sheet that is being conveyed.

### Description of Related the Art

JP 2013-230881 A describes a sheet conveyance apparatus including a separation/press-contact mechanism that brings a registration roller pair into a separated state and into a press-contact state.

However, there is still room for further improvement in the registration roller pair to be brought into the separated state and into the contact state.

### SUMMARY

The present disclosure provides an improved technique related to a sheet conveyance apparatus, an image forming apparatus, and an image forming system, each including a roller pair that can be brought into a contact state and into a separated state.

According to some embodiments of the present disclosure, a sheet conveyance apparatus includes a conveyance unit configured to convey a sheet in a conveyance direction, a first roller pair disposed downstream of the conveyance unit in the conveyance direction, the first roller pair including a first driving roller configured to rotate about a first rotation shaft, and a first driven roller disposed to face the first driving roller and configured to rotate about a second rotation shaft while being driven by the first driving roller, a switching mechanism configured to switch between a contact state in which the first driven roller and the first driving roller are brought into contact with each other, and a separated state in which the first driven roller and the first driving roller are separated from each other, a first conveyance driving unit configured to rotate the first driving roller about the first rotation shaft, a first turn driving unit configured to turn the first driving roller about a first turning shaft extending in an intersecting direction intersecting both the conveyance direction and a width direction of the sheet orthogonal to the conveyance direction, a first turning support configured to support the first driven roller to be turnable about a second turning shaft extending in the intersecting direction, and a control unit configured to start a print job, and execute a first operation of bringing the switching mechanism into the contact state and rotate the first driving roller by the first conveyance driving unit before a leading edge of the sheet conveyed by the conveyance unit reaches the first roller pair, so that the first driven roller is turned to follow the first driving roller while being driven by the first driving roller.

According to a second aspect of the present disclosure, an image forming apparatus includes the sheet conveyance apparatus, and an image forming unit configured to form an image on a sheet conveyed by the sheet conveyance apparatus.

According to a third aspect of the present disclosure, an image forming system includes the image forming apparatus, and a processing apparatus configured to perform processing on a sheet on which an image is formed by the image forming apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a schematic configuration of an inkjet recording system according to the present embodiment.

FIG. 2 is a block diagram illustrating a control system of the inkjet recording system according to the present embodiment.

FIG. 3 is a perspective view illustrating a registration unit according to the present embodiment.

FIG. 4 is a cross-sectional view illustrating the registration unit according to the present embodiment.

FIG. 5A is a side view illustrating a left roller pair according to the present embodiment.

FIG. 5B is a side view illustrating a right roller pair according to the present embodiment.

FIG. 6A is a perspective view illustrating a case in which a velocity vector in the roller pair according to the present embodiment is located at a reference position along the center of conveyance.

FIG. 6B is a perspective view illustrating a case where the velocity vector in the roller pair according to the present embodiment has turned from the reference position.

FIG. 7A is a plan view illustrating a case where left and right velocity vectors in the roller pair according to the present embodiment are different at the reference position.

FIG. 7B is a plan view illustrating a case where the left and right velocity vectors in the roller pair according to the present embodiment have turned from the reference position.

FIG. 8A is a diagram illustrating a case where steering directions of a driving roller and a driven roller according to the present embodiment align with each other.

FIG. 8B is a diagram illustrating a case where the steering directions of the driving roller and the driven roller according to the present embodiment do not align with each other.

FIG. 9A is a diagram illustrating a case where the steering directions of the driving roller and the driven roller according to the present embodiment do not align with each other.

FIG. 9B is a diagram illustrating a case where the driven roller has turned as the driving roller has rotated according to the present embodiment.

FIG. 9C is a diagram illustrating a case where the steering directions according to the present embodiment align with each other.

FIG. 10 is a flowchart illustrating operations of an attaching/detaching apparatus and a pair of left and right rollers according to the present embodiment.

### DESCRIPTION OF THE EMBODIMENTS

Hereinafter, various exemplary embodiments, features, and aspects for carrying out the present disclosure will be described with reference to the drawings. In the present embodiment, a case where an inkjet recording system 1 is applied as an image forming system will be described.

### Inkjet Recording System

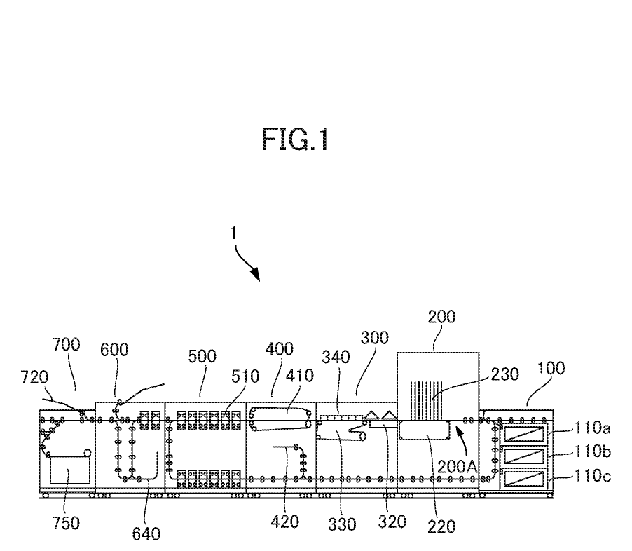

First, a schematic configuration of the inkjet recording system 1 according to the present embodiment will be described with reference to FIG. 1. FIG. 1 is a schematic diagram illustrating the schematic configuration of the inkjet recording system 1 according to the present embodiment. The inkjet recording system 1 serving as an image forming system is a sheet-type inkjet recording system that produces a recorded material by forming an ink image on a sheet S using two liquids: a reaction liquid and an ink. As illustrated in FIG. 1, the inkjet recording system 1 includes a feeding module 100, a printing module 200, a drying module 300, a fixing module 400, a cooling module 500, a reversing module 600, and a discharging module 700. A cut-sheet type sheet S supplied from the feeding module 100 is conveyed along a conveyance path, processed in each module, and discharged by the discharging module 700 serving as a sheet stacking apparatus. In addition, in the inkjet recording system 1, an image is formed on a sheet by the printing module 200 serving as an image forming apparatus, and various processes are performed on the sheet on which the image is formed downstream of the printing module 200 in a sheet conveyance direction. Therefore, the drying module 300, the fixing module 400, the cooling module 500, the reversing module 600, the discharging module 700, and the like correspond to a processing apparatus.

The feeding module 100 includes three storage compartments 110a, 110b, and 110c that store sheets S. Each of the storage compartments 110a, 110b, and 110c is configured to be drawable toward the front side of the apparatus. The sheets S are fed one by one by a separation belt and a conveyance roller (not illustrated) in each of the storage compartments 110a, 110b, and 110c, and conveyed to the printing module 200. The number of the storage compartments 110a, 110b, and 110c is not limited to three, and may be one, two, or four or more.

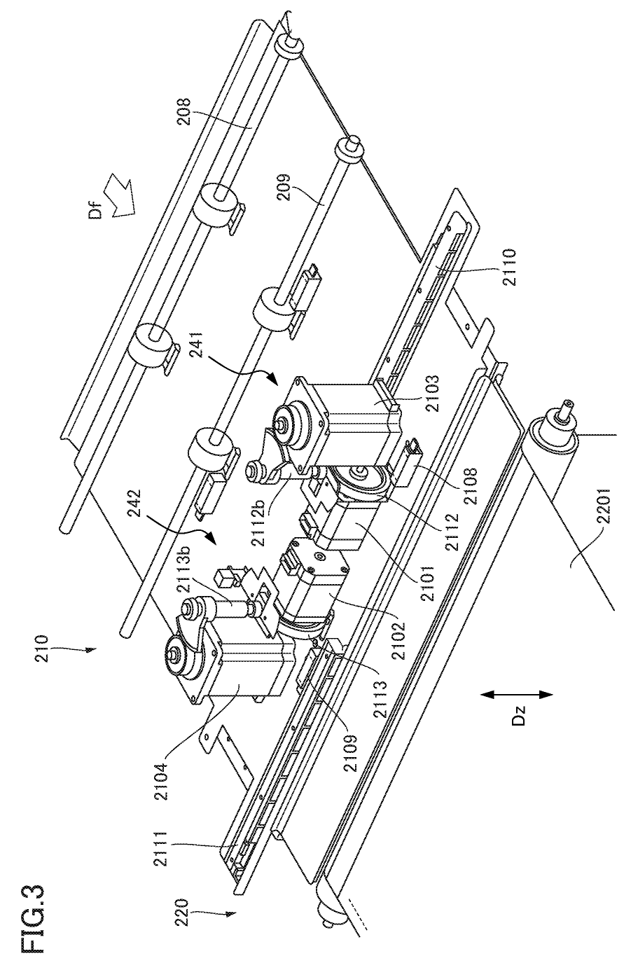

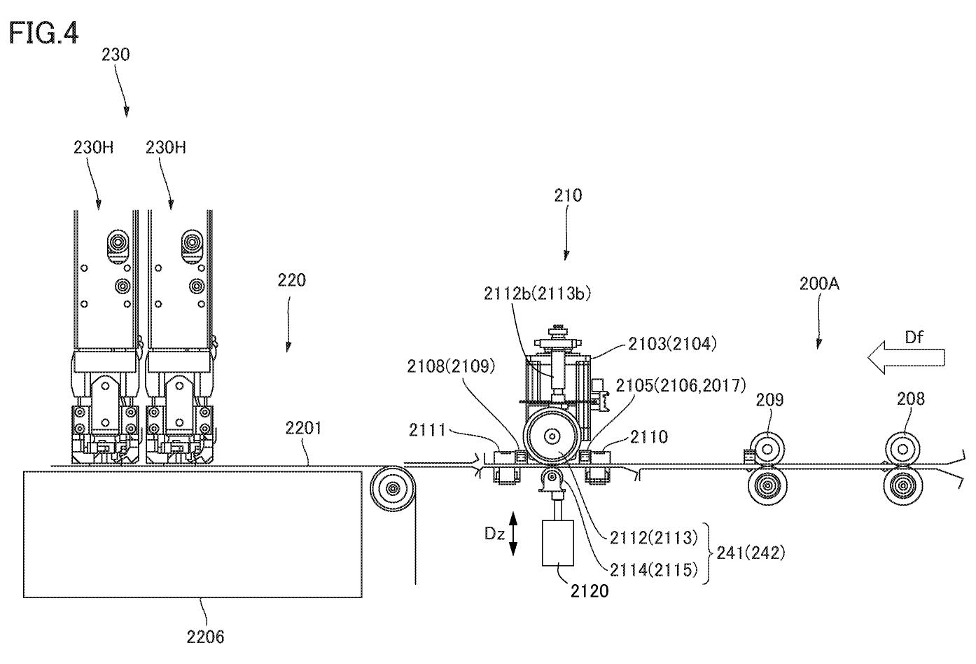

The printing module 200 includes a registration unit 210 (see FIG. 3) serving as a skew feeding correction unit that performs skew feeding correction and lateral registration correction before image formation, which will be described in detail below, a printing belt unit 220, and a recording unit 230. The sheet S conveyed from the feeding module 100 is conveyed to the printing belt unit 220 after the inclination and position of the sheet are corrected by a plurality of conveyance roller pairs 208 and 209 (see FIG. 3) serving as a conveyance unit and the registration unit 210. The recording unit 230 is disposed at a position of the conveyance path facing the printing belt unit 220. The plurality of conveyance roller pairs 208 and 209 and the registration unit 210 constitute a sheet conveyance unit 200A serving as a sheet conveyance apparatus that conveys a sheet to the recording unit 230. In addition, the recording unit 230 constitutes an image forming unit that forms an image by performing recording processing (printing) on the sheet S conveyed by the sheet conveyance unit 200A using a plurality of recording heads 230H (see FIG. 4) from above the sheet S.

The plurality of recording heads 230H are arranged in a row along the sheet conveyance direction. In the present embodiment, there are a total of five line-type recording heads corresponding to the reaction liquid in addition to four colors: yellow (Y), magenta (M), cyan (C), and black (Bk). Note that the number of colors is not limited to four, and the number of recording heads is not limited to five. Further, as an inkjet method, a method using a heat generating element, a method using a piezoelectric element, a method using an electrostatic element, a method using a micro-electro-mechanical systems (MEMS) element, or the like can be adopted. The ink of each color is supplied to the recording head from an ink tank (not illustrated) via a corresponding ink tube. The sheet S printed by the recording unit 230 is sucked and conveyed by the printing belt unit 220, thereby being conveyed while securing a clearance with the recording head. In the sheet S printed by the recording unit 230, a deviation and a color density of an image formed on the sheet S are detected by an in-line scanner (not illustrated) disposed downstream of the recording unit in the sheet conveyance direction. The detection result is used to correct the printed image.

Here, the conveyance speed of the sheet S from the printing module 200 to the fixing module 400, which will be described below, is set to, for example, 675.65 millimeters per second (mm/s). In order to secure the time for the drying step and the fixing step, which will be described below, the conveyance speed is set to the upper limit.

The drying module 300 includes a decoupling unit 320, a drying belt unit 330, and a hot air blowing unit 340, and reduces the amount of liquid contained in the ink applied onto the sheet S by the recording unit 230 of the printing module 200, thereby enhancing fixability of the ink onto the sheet S. The sheet S printed by the recording unit 230 of the printing module 200 is conveyed to the decoupling unit 320 disposed upstream of the drying module 300 in the sheet conveyance direction. In the decoupling unit 320, the sheet S can be conveyed by wind pressure from above and by friction of the belt. By weakly holding and conveying the sheet S on the belt, the sheet S is prevented from deviating on the printing belt unit 220 that forms an ink image. The drying belt unit 330 is disposed below the belt, and the hot air blowing unit 340 is disposed above the belt so as to face each other with the belt interposed therebetween. The sheet S conveyed from the decoupling unit 320 is sucked and conveyed by the drying belt unit 330, and at the same time, an ink-applied surface of the sheet S is dried by receiving hot air from the hot air blowing unit 340. The drying method may be a combination of a method in which the surface of the sheet S is irradiated with electromagnetic waves (ultraviolet rays, infrared rays, or the like) or a method in which conductive heat is transferred by contacting a heating element with the method in which the hot air is applied.

The fixing module 400 includes a fixing belt unit 410. The fixing belt unit 410 includes an upper belt unit and a lower belt unit, and can fix the ink onto the sheet S by allowing the sheet S conveyed from the drying module 300 to pass between the heated upper and lower belt units.

The cooling module 500 includes a plurality of cooling units 510, and cools the high-temperature sheet S conveyed from the fixing module 400. The cooling units 510 are configured to cool the sheet S by taking outside air into a cooling box using a fan to increase the pressure in the cooling box, and applying air blown out from a nozzle formed in a conveyance guide to the sheet S. The cooling units 510 are disposed both above and below the conveyance path, and cool the sheet S from both sides.

The cooling module 500 includes a conveyance path switching unit, and can switch the conveyance path of the sheet S depending on whether the sheet S is to be conveyed to the reversing module 600 or to a duplex conveyance path used for duplex printing. For duplex printing, the sheet S is conveyed to a conveyance path below the cooling module 500. In this case, the sheet is further conveyed from the cooling module 500 along the duplex conveyance path through the fixing module 400, the drying module 300, the printing module 200, and the feeding module 100. A first reversing unit 420 that reverses the front and back sides of the sheet S is provided in the duplex conveyance path of the fixing module 400. Then, the sheet is conveyed again from the feeding module 100 to the pre-image formation registration correction unit, the printing belt unit 220, and the recording unit 230 of the printing module 200, and is printed by the recording unit 230.

The reversing module 600 includes a second reversing unit 640, and can reverse the front and back sides of the conveyed sheet S and change the front and back sides of the sheet S to be discharged. The discharging module 700 includes a top tray 720 and a sheet stacking unit 750, and aligns and stacks the sheet S conveyed from the reversing module 600 on the top tray 720 and the sheet stacking unit 750, or discharges the sheet S to an external tray (not illustrated) or the like.

### Block Diagram of Inkjet Recording System

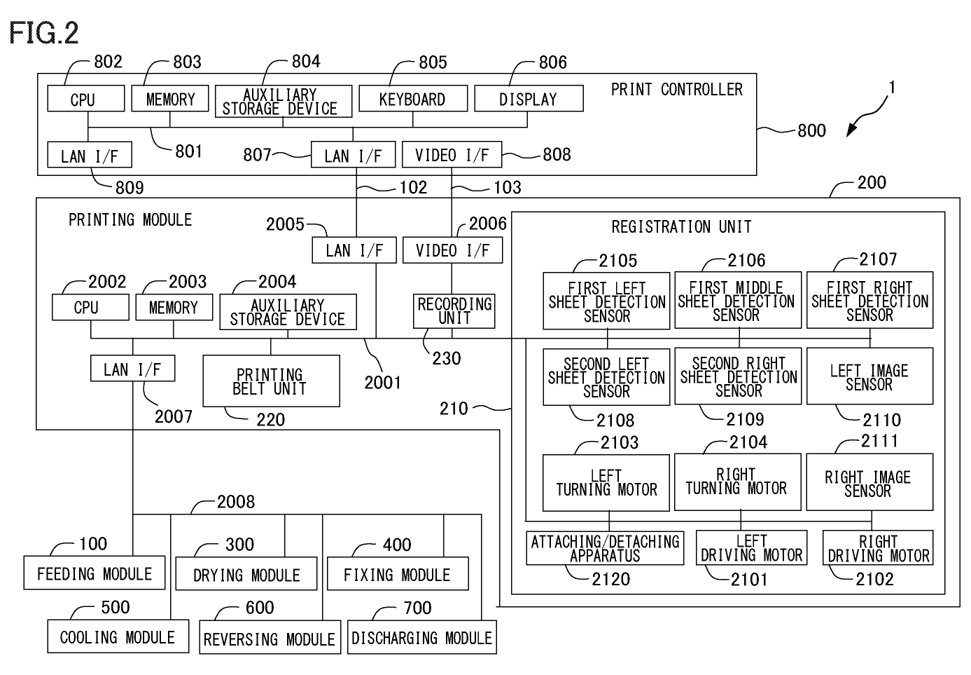

Next, a block diagram of a control system of the inkjet recording system 1 will be described with reference to FIG. 2. FIG. 2 is a block diagram illustrating a control configuration of the inkjet recording system 1. Here, in particular, components that control the registration function will be described. The printing module 200 includes a bus 2001, a central processing unit (CPU) 2002, a memory 2003, an auxiliary storage device 2004, a local area network (LAN) interface 2005 (LAN I/F), a video interface 2006 (video I/F), and a LAN interface 2007. In addition, the printing module 200 includes a printing belt unit 220, a recording unit 230, and a registration unit 210. The bus 2001 connects the components of the printing module 200.

The CPU 2002 is an example of a controller or control unit, and controls the printing module 200 based on programs stored in the auxiliary storage device 2004. The registration unit 210 is controlled by the CPU 2002. The memory 2003 stores programs and data used when the CPU 2002 performs processes, and operates as a work area. The auxiliary storage device 2004 is a non-volatile storage device that stores programs for controlling the apparatus and data used for control. The auxiliary storage device 2004 is, for example, an HDD or an SSD.

The LAN interface 2005 is connected to an external LAN 102, through which communication such as reception of print instructions from a print controller 800 is performed. The video interface 2006 is connected to a video cable 103, through which communication such as reception of image data transmitted from the print controller 800 is performed, and the received image data is transmitted to the recording unit 230. The LAN interface 2007 is connected to an internal LAN 2008. Communication between the feeding module 100, the printing module 200, the drying module 300, the fixing module 400, the cooling module 500, the reversing module 600, and the discharging module 700 is performed via the LAN interface 2007.

The registration unit 210 includes a left driving motor 2101, a right driving motor 2102, a left turning motor 2103, a right turning motor 2104, a first left sheet detection sensor 2105, and a first middle sheet detection sensor 2106. In addition, the registration unit 210 includes a first right sheet detection sensor 2107, a second left sheet detection sensor 2108, a second right sheet detection sensor 2109, a left image sensor 2110, a right image sensor 2111, and an attaching/detaching apparatus 2120. The first left sheet detection sensor 2105, the first middle sheet detection sensor 2106, and the first right sheet detection sensor 2107 are disposed downstream of a left roller pair 241 and a right roller pair 242 in the sheet conveyance direction Df in the vicinity of the left roller pair 241 and the right roller pair 242 (see FIG. 4). The second left sheet detection sensor 2108 and the second right sheet detection sensor 2109 are disposed downstream of the left roller pair 241 and the right roller pair 242 in the sheet conveyance direction Df and in vicinity of the left roller pair 241 and the right roller pair 242 (see FIG. 4). The sheet conveyance direction Df is an example of a conveyance direction.

The left driving motor 2101, the right driving motor 2102, the left turning motor 2103, and the right turning motor 2104 are actuators for performing registration such as skew feeding correction and lateral deviation correction, and operate in accordance with instructions from the CPU 2002. The first left sheet detection sensor 2105, the first middle sheet detection sensor 2106, the first right sheet detection sensor 2107, the second left sheet detection sensor 2108, and the second right sheet detection sensor 2109 are sensors for performing registration. These sensors detect timings at which a leading edge of a sheet reaches these sensors and timings at which a trailing edge of the sheet passes through these sensors. The CPU 2002 can acquire the detected timings.

The left image sensor 2110 and the right image sensor 2111 are sensors that measure positions of edge portions (left and right edges) of a sheet in a width direction. The CPU 2002 can acquire the measured positions. The left image sensor 2110 and the right image sensor 2111 include, for example, contact image sensors (CISs) whose longitudinal direction is the width direction. The attaching/detaching apparatus 2120 operates in accordance with an instruction from the CPU 2002. The recording unit 230 performs recording based on image data received from the video interface 2006 and a recording start signal from the CPU 2002.

The print controller 800 includes a bus 801, a CPU 802, a memory 803, an auxiliary storage device 804, a keyboard 805, a display 806, a LAN interface 807, a video interface 808, and a LAN interface 809. The bus 801 connects the components of the print controller 800.

Based on programs and data stored in the auxiliary storage device 804, the CPU 802 comprehensively executes processes such as reception of print instructions from a print job registration personal computer (PC) (not illustrated), raster image processor (RIP) processing, and transmission of print data to the printing module 200. The memory 803 stores programs and data used when the CPU 802 performs various processes, and operates as a work area. The auxiliary storage device 804 stores programs and data used for operations such as printing processing. The auxiliary storage device 804 may be, for example, a hard disk drive (HDD), a solid state drive (SSD), or the like.

The keyboard 805 is a device for inputting an operation instruction to the print controller 800. On the display 806, information such as applications executed by the print controller 800 is displayed by still-image or moving-image video signals. The LAN interface 807 is connected to the external LAN 102, through which communication such as transmission of print instructions to the printing module 200 is performed. The video interface 808 is connected to the video cable 103, through which communication such as transmission of image data to the printing module 200 is performed. The LAN interface 809 is connected to an external LAN (not illustrated), through which communication such as reception of print instructions from a print job registration PC (not illustrated) is performed.

### Registration Unit

Next, a schematic configuration of the registration unit 210 will be described with reference to FIGS. 3 and 4. FIG. 3 is a perspective view illustrating the registration unit of the printing module according to the present embodiment. FIG. 4 is a side cross-sectional view illustrating the registration unit of the printing module according to the present embodiment.

In the printing module 200, as illustrated in FIGS. 3 and 4, the conveyance roller pairs 208 and 209 that convey a sheet are sequentially arranged in the sheet conveyance direction Df in the sheet conveyance unit 200A (see FIG. 1). Each of the conveyance roller pairs 208 and 209 includes a lower roller including a roller made of, for example, EPDM and an upper roller that is a rubber roller made of, for example, urethane, and the lower roller is biased toward the upper roller by a spring (not illustrated). Note that the sheet conveyance direction Df mentioned here refers to a direction in a case where the sheet S is not skewed, and does not refer to a conveyance direction in a steering operation, which will be described below.

In the sheet conveyance unit 200A of the printing module 200, a registration unit 210 that corrects skew feeding of the sheet conveyed by the conveyance roller pairs 208 and 209 is disposed downstream of the conveyance roller pairs 208 and 209 in the sheet conveyance direction Df. Further, a printing belt unit 220 is disposed, in the printing module 200, downstream of the registration unit 210 in the sheet conveyance direction Df. The printing belt unit 220 includes a printing belt 2201 that circulates so as to suck and convey a sheet, and a recording unit 230 (a plurality of recording heads 230H) that forms an image on the sheet conveyed by the printing belt 2201.

The registration unit 210 includes a left roller pair 241 and a right roller pair 242. The left roller pair 241 includes a left driving roller 2112 and a left driven roller 2114, and the right roller pair 242 includes a right driving roller 2113 and a right driven roller 2115. The left roller pair 241 is an example of a first roller pair, and is disposed downstream of the conveyance roller pairs 208 and 209 in the sheet conveyance direction Df. The left driving roller 2112 is an example of a first driving roller, and rotates about a first rotation shaft 2112a. The left driven roller 2114 is an example of a first driven roller, is disposed to face the left driving roller 2112, and rotates about a second rotation shaft 2116 while being driven by the left driving roller 2112. The right roller pair 242 is an example of a second roller pair, and is disposed alongside the left roller pair 241 in the width direction orthogonal to the sheet conveyance direction Df. The right driving roller 2113 is an example of a second driving roller, and rotates around a third rotation shaft 2113a. The right driven roller 2115 is an example of a second driven roller, is disposed to face the right driving roller 2113, and rotates about a fourth rotation shaft 2118 while being driven by the right driving roller 2113.

The left driving roller 2112 and the right driving roller 2113 are configured to be rotated about their respective rotation shafts in a direction for conveying a sheet by the left driving motor 2101 and the right driving motor 2102, respectively. That is, the left driving motor 2101 is an example of a first conveyance driving unit, and rotates the left driving roller 2112 about the first rotation shaft 2112a. The right driving motor 2102 is an example of a second conveyance driving unit, and rotates the right driving roller 2113 about the third rotation shaft 2113a.

The left driving roller 2112 and the right driving roller 2113 are configured to be turned in a steering direction by the left turning motor 2103 and the right turning motor 2104. That is, the left turning motor 2103 is an example of a first turn driving unit, and turns the left driving roller 2112 about a first turning shaft 2112b extending in a vertical direction Dz. The first rotation shaft 2112a and the first turning shaft 2112b intersect each other. Here, the vertical direction Dz is an intersecting direction intersecting both the sheet conveyance direction Df and the width direction. The right turning motor 2104 is an example of a second turn driving unit, and turns the right driving roller 2113 about a third turning shaft 2113b extending in the vertical direction Dz. The third rotation shaft 2113a and the third turning shaft 2113b intersect each other.

The sheet conveyed through the registration unit 210 advances from the upper right to the lower left in FIG. 3. The sheet is nipped between the left roller pair 241 and the right roller pair 242, and registration is performed. Thereafter, the sheet is conveyed to the printing belt unit 220.

The first left sheet detection sensor 2105, the first middle sheet detection sensor 2106, and the first right sheet detection sensor 2107 are disposed upstream of the left driving roller 2112 and the right driving roller 2113 in the sheet conveyance direction Df. They are disposed at different positions on the left and right with respect to the sheet conveyance direction Df in order to calculate an amount of skew feeding based on the timings at which the leading edge of the sheet passes. The amount of skew feeding of the sheet before registration can be acquired from these sensors.

The second left sheet detection sensor 2108 and the second right sheet detection sensor 2109 are disposed downstream of the left driving roller 2112 and the right driving roller 2113 in the sheet conveyance direction Df. They are disposed at different positions on the left and right with respect to the sheet conveyance direction Df in order to calculate an amount of skew feeding based on the timings at which the leading edge of the sheet passes. The amount of skew feeding of the sheet during registration can be acquired from these sensors. The left image sensor 2110 and the right image sensor 2111 are disposed on both sides in the width direction of the registration unit 210 in order to measure the positions of the left and right edges of the sheet.

FIG. 4 is a side view of the periphery of the registration unit 210 illustrating an operation in which the driven rollers constituting the left roller pair 241 and the right roller pair 242 are attached and detached by the attaching/detaching apparatus 2120. First, the positions of the left driven roller 2114 and the right driven roller 2115 and the attaching/detaching operation performed by the attaching/detaching apparatus 2120 will be described. The attaching/detaching operation performed by the attaching/detaching apparatus 2120 is performed so that the registration unit 210 does not apply a force to the sheet on which an image is being formed.

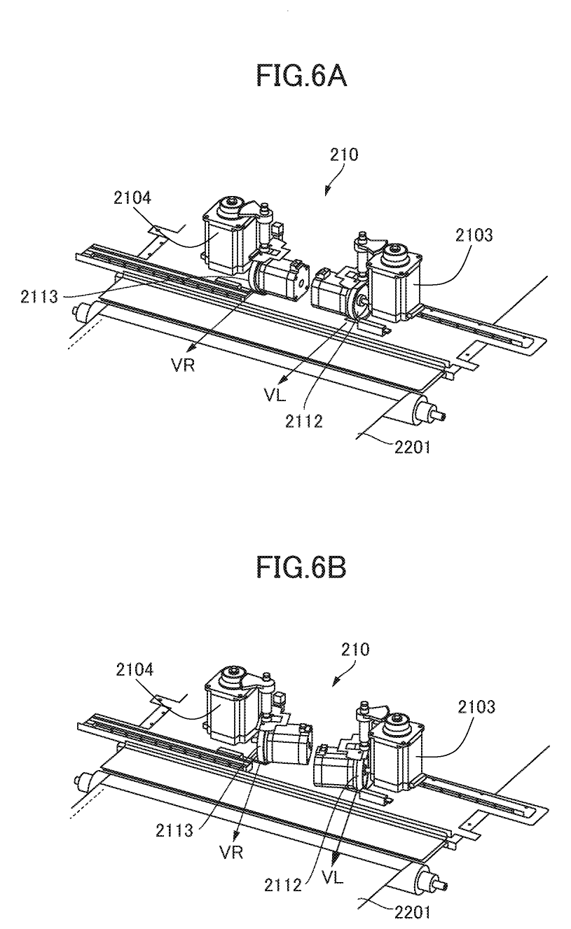

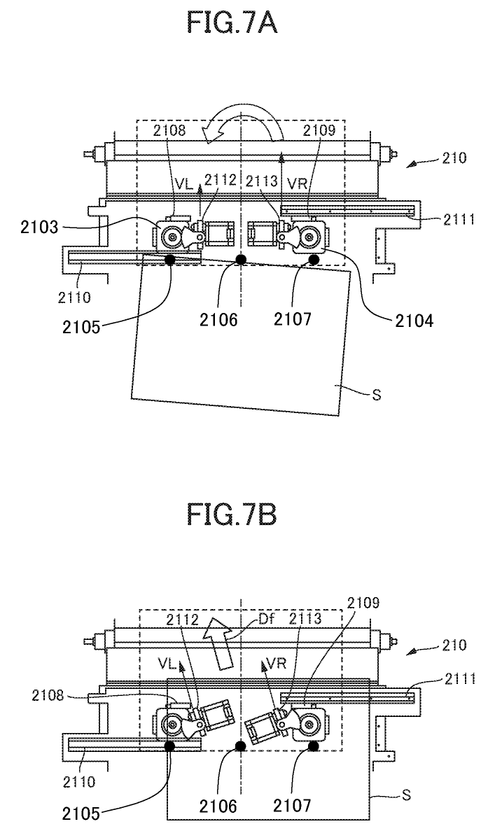

The left driven roller 2114 and the right driven roller 2115 are disposed at positions facing the left driving roller 2112 and the right driving roller 2113, respectively. Nip portions 241N and 242N are formed between the left driving roller 2112 and the left driven roller 2114 and between the right driving roller 2113 and the right driven roller 2115, respectively, and the sheet is nipped in the nip portions 241N and 242N for conveyance and registration. The conveyance and registration operations will be described below with reference to FIGS. 6A-7B.

The attaching/detaching apparatus 2120 attaches and detaches the left driving roller 2112 and the left driven roller 2114, and the right driving roller 2113 and the right driven roller 2115 by moving the left driven roller 2114 and the right driven roller 2115, respectively, in the vertical direction Dz. The attaching/detaching apparatus 2120 converts a rotational motion into a linear motion, for example, using a motor and a cam. The attaching/detaching apparatus 2120 is an example of a switching mechanism, and switches between a contact state and a separated state. The contact state is a state in which the left driving roller 2112 and the left driven roller 2114 are in contact with each other, and the right driving roller 2113 and the right driven roller 2115 are in contact with each other. The separated state is a state in which the left driving roller 2112 and the left driven roller 2114 are separated from each other, and the right driving roller 2113 and the right driven roller 2115 are separated from each other. In the present embodiment, the attaching/detaching apparatus 2120 is configured using a motor and a cam, but the configuration of the attaching/detaching apparatus 2120 is not limited thereto, and the attaching/detaching apparatus 2120 may be configured using a solenoid or the like. In addition, the attaching/detaching apparatus 2120 is configured to convert a rotational motion into a linear motion, but may be configured to perform only a linear motion.

The attaching/detaching operation performed by the attaching/detaching apparatus 2120 is executed to eliminate the influence of the registration unit 210 on the sheet during image formation. The sheet that has passed through the registration unit 210 reaches the printing belt unit 220. The sheet is sucked and conveyed on the printing belt unit 220 by the printing belt 2201 having fine holes and a vacuum box 2206 to which negative pressure is applied by a fan (not illustrated). The vacuum box 2206 is an example of a downstream conveyance unit, and is disposed downstream of the left roller pair 241 and the right roller pair 242 in the sheet conveyance direction Df. The conveyance on the printing belt unit 220 may involve highly accurate conveyance control. On the other hand, by separating the roller pair using the attaching/detaching apparatus 2120, the registration unit 210 does not affect the sheet on which an image is being formed.

### Roller Pair

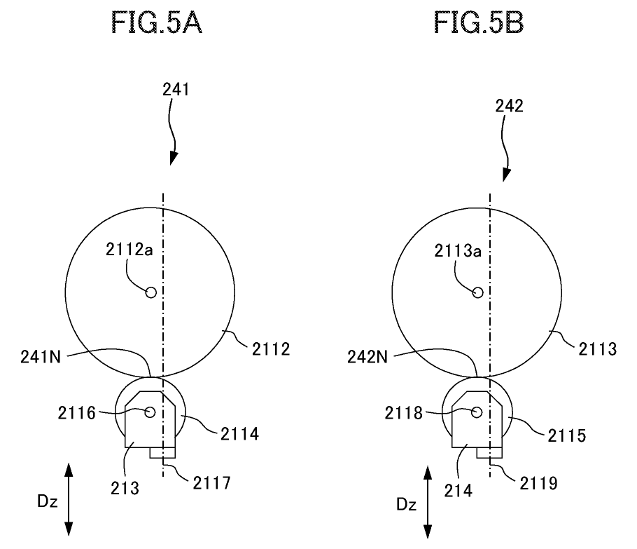

FIG. 5A is a side view illustrating a configuration of the left roller pair 241, and FIG. 5B is a side view illustrating a configuration of the right roller pair 242. First, a positional relationship between the left driving roller 2112 and the left driven roller 2114 of the left roller pair 241 and a configuration of the left driven roller 2114 will be described with reference to FIG. 5A. The left driving roller 2112 and the left driven roller 2114 are disposed at positions facing each other, and form the nip portion 241N in the contact state. At this time, as the left driving roller 2112 is rotationally driven, the left driven roller 2114 is driven to rotate.

The left driven roller 2114 is supported by a first turning support 213 so as to be turnable about a second turning shaft 2117 extending in the vertical direction Dz. The left driven roller 2114 includes a second rotation shaft 2116 and a second turning shaft 2117. The second rotation shaft 2116 is a shaft that enables the left driven roller 2114 to rotate in the conveyance direction. The second turning shaft 2117 is a shaft that enables the left driven roller 2114 to turn in the steering direction. The second turning shaft 2117 does not intersect the second rotation shaft 2116, and is eccentric to the second rotation shaft 2116.

In the present embodiment, when viewed in an axial direction of the second rotation shaft 2116, the second rotation shaft 2116 is located downstream of the second turning shaft 2117 in the sheet conveyance direction Df, and the shortest distance between the second rotation shaft 2116 and the second turning shaft 2117 is set to 5 mm. However, the shortest distance between the second rotation shaft 2116 and the second turning shaft 2117 is not limited to 5 mm, and may be within a range in which the left driven roller 2114 contacts the left driving roller 2112 even if the left driven roller 2114 rotates to its maximum extent. In addition, the range in which the left driven roller 2114 is movable in the turning direction is set to ±15 degrees with respect to the central reference position. When the left driving roller 2112 and the left driven roller 2114 are in the separated state, the left driven roller 2114 can freely rotate about the second rotation shaft 2116 and the second turning shaft 2117.

Next, a positional relationship between the right driving roller 2113 and the right driven roller 2115 of the right roller pair 242 and a configuration of the right driven roller 2115 will be described with reference to FIG. 5B. The right driving roller 2113 and the right driven roller 2115 are disposed at positions facing each other, and form the nip portion 242N in the contact state. At this time, as the right driving roller 2113 is rotationally driven, the right driven roller 2115 is driven to rotate.

The right driven roller 2115 is supported by a second turning support 214 so as to be turnable about a fourth turning shaft 2119 extending in the vertical direction Dz. The right driven roller 2115 includes a fourth rotation shaft 2118 and a fourth turning shaft 2119. The fourth rotation shaft 2118 is a shaft that enables the right driven roller 2115 to rotate in the conveyance direction. The fourth turning shaft 2119 is a shaft that enables the right driven roller 2115 to turn in the steering direction. The fourth turning shaft 2119 does not intersect the fourth rotation shaft 2118, and is eccentric to the fourth rotation shaft 2118.

In the present embodiment, the fourth rotation shaft 2118 is located downstream of the fourth turning shaft 2119 in the sheet conveyance direction Df, and the shortest distance between the fourth rotation shaft 2118 and the fourth turning shaft 2119 is set to 5 mm. However, the shortest distance between the fourth rotation shaft 2118 and the fourth turning shaft 2119 is not limited to 5 mm, and may be within a range in which the right driven roller 2115 contacts the right driving roller 2113 even if the right driven roller 2115 rotates to its maximum extent. In addition, the range in which the right driven roller 2115 is movable in the turning direction is set to ±15 degrees with respect to the central reference position. When the right driving roller 2113 and the right driven roller 2115 are in the separated state, the right driven roller 2115 can freely rotate about the fourth rotation shaft 2118 and the fourth turning shaft 2119.

### Operation of Registration Unit

FIGS. 6A-7B are detailed operation diagrams illustrating an operation in which a sheet is corrected by registration control. An operation of the registration unit 210 for correcting skew feeding and lateral deviation of the sheet S will be described with reference to FIGS. 6A-7B.

FIG. 6A illustrates a velocity vector for each roller pair. A velocity vector VL is a velocity vector of the nip portion 241N of the left roller pair 241. A velocity vector VR is a velocity vector of the nip portion 242N of the right roller pair 242. The lengths of the velocity vector VL and the velocity vector VR can be changed by the driving speeds of the left driving motor 2101 and the right driving motor 2102.

FIG. 6B illustrates an example in which the sheet conveyance direction Df is changed by a steering mechanism. By driving the left turning motor 2103 and the right turning motor 2104, the left roller pair 241 and the right roller pair 242 are rotated in the respective turning directions. As a result, the directions of the velocity vector VR and the velocity vector VL can be changed.

FIG. 7A illustrates an example in which skew feeding of a sheet is corrected by a speed difference between roller pairs. When the sheet S enters the registration unit 210, the leading edge of the sheet S is detected by the first left sheet detection sensor 2105, the first middle sheet detection sensor 2106, and the first right sheet detection sensor 2107 before passing through the left roller pair 241 and the right roller pair 242. Thereafter, after the sheet S passes through the left roller pair 241 and the right roller pair 242, the leading edge of the sheet S is detected by the second left sheet detection sensor 2108 and the second right sheet detection sensor 2109.

At this time, if the sheet is skewed, a time difference occurs in detection timing between the first left sheet detection sensor 2105, the first middle sheet detection sensor 2106, and the first right sheet detection sensor 2107. Similarly, if the sheet is skewed, a time difference occurs in detection timing between the second left sheet detection sensor 2108 and the second right sheet detection sensor 2109. The CPU 2002 calculates an amount of skew feeding of the sheet S from the leading edge detection timings, the conveyance speeds, and the sensor intervals. The CPU 2002 performs feedback control to provide a speed difference between the left driving motor 2101 and the right driving motor 2102 based on the calculated amount of skew feeding. Then, there is a speed difference between the velocity vector VL and the velocity vector VR, thereby correcting skew feeding.

FIG. 7B illustrates an example in which a position of a sheet is corrected by a steering mechanism. When the sheet S enters the registration unit 210 with lateral deviation, the CPU 2002 calculates an amount of lateral deviation of the sheet S from values measured by the left image sensor 2110 and the right image sensor 2111. The left turning motor 2103 and the right turning motor 2104 are feedback-controlled. As a result, the velocity vector VL and the velocity vector VR are oriented to correct the lateral deviation, thereby correcting lateral deviation.

### Deterioration in Registration Accuracy

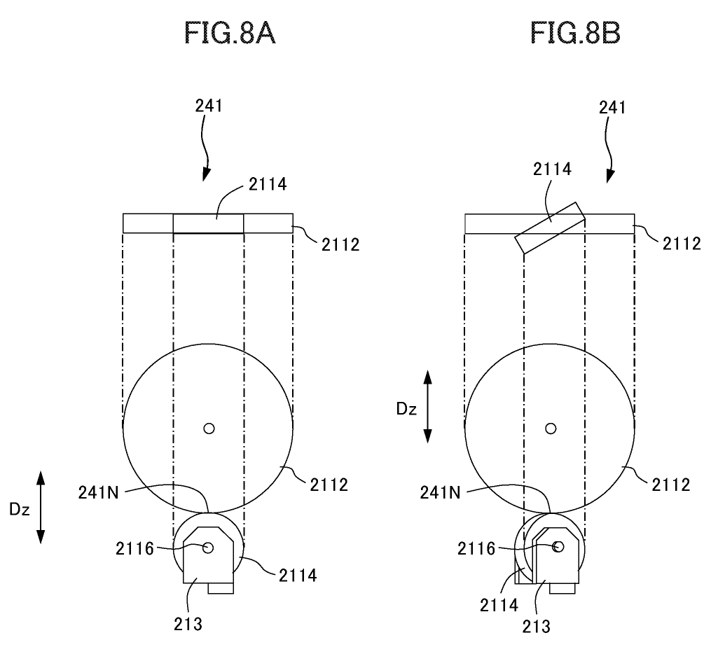

FIGS. 8A and 8B are explanatory diagrams illustrating an example in which the steering direction of the driving roller and the steering direction of the driven roller are different. In FIGS. 8A and 8B, the upper diagrams are plan views, and the lower views are side views. Concerning the steering direction of the driving roller and the steering direction of the driven roller, an ideal state and a state in which the registration accuracy deteriorates will be described. Here, the left roller pair 241 will be described, but the same applies to the right roller pair 242.

FIG. 8A illustrates an ideal relationship between the steering direction of the left driving roller 2112 and the steering direction of the left driven roller 2114. That is, a state in which the steering directions of the left driving roller 2112 and the left driven roller 2114 align with each other is ideal. At this time, the sheet is conveyed in the steering direction of the left roller pair 241.

On the other hand, FIG. 8B illustrates an example in which the steering direction of the left driving roller 2112 and the steering direction of the left driven roller 2114 are different from each other. When the steering direction of the left driven roller 2114 is different from the steering direction of the left driving roller 2112 in this manner, the sheet is not conveyed in the steering direction of the left driving roller 2112, and the correction accuracy may deteriorate. Therefore, when the steering direction of the left driving roller 2112 and the steering direction of the left driven roller 2114 are different from each other, there is a problem that registration is performed with a deterioration in correction accuracy. Such a situation in which the steering directions are different occurs when a force for turning the left driven roller 2114 is applied while the left driving roller 2112 and the left driven roller 2114 are in the separated state. For example, this occurs when a user accidentally touches the left driven roller 2114 during sheet jam handling processing.

On the other hand, in the registration unit 210 having the steering configuration as in the present embodiment, it is important that the steering direction of the driven roller aligns with the steering direction of the driving roller when correcting skew feeding and lateral deviation of the sheet. This is because if the steering directions of the driving roller and the driven roller do not align with each other, the roller pair nips the sheet, and the sheet cannot be conveyed in a direction for correction.

In general, in an image forming apparatus, in order to achieve favorable image formation, a sheet may be conveyed only by a conveyance member of the image forming unit, during image formation, rather than being conveyed while being nipped between the conveyance member of the image forming unit and a conveyance member of the registration unit located upstream of the conveyance member of the image forming unit. This is because, when an image is formed on a sheet, highly accurate sheet conveyance may be desirable, and conveyance members other than the conveyance member of the image forming unit may have no influence on the sheet on which the image is being formed. Therefore, JP 2013-230881 A discloses an example in which an attaching/detaching apparatus that brings a roller pair of a registration unit into a contact state and into a separated state is used to eliminate any influence on a sheet on which an image is being formed. In this configuration, when the leading edge of the sheet reaches the roller pair of the registration unit, the roller pair is brought into the contact state, skew feeding and lateral deviation are corrected, and the roller pair of the registration unit is separated after the sheet reaches image forming unit located downstream of the registration unit.

However, JP 2013-230881 A does not target a registration unit including a steering mechanism. If the registration unit includes a steering mechanism, there is a possibility that the driven roller turns due to a factor such as a user’s touch on the driven roller while the roller pair is separated, and the steering directions of the driving roller and the driven roller do not align with each other. If the roller pair is brought into the contact state and the sheet is corrected while the steering directions of the driving roller and the driven roller do not align with each other, the sheet is received immediately after the roller pair is brought into the contact state, and the sheet is corrected in a state where the steering direction of the driving roller and the steering direction of the driven roller do not align with each other. In this manner, if the steering directions of the driving roller and the driven roller do not align with each other, the sheet is not conveyed in the steering direction of the driving roller, and the sheet correction accuracy may deteriorate.

### Operation of Making Steering Directions of Driving Roller and Driven Roller to Align

Therefore, in the present embodiment, in order to solve the above-described deterioration in correction accuracy when the steering directions of the driving roller and the driven roller are different, the steering directions of the driving roller and the driven roller are made to align with each other. First, the principle and control for turning the driven roller by driving the driving roller will be described.

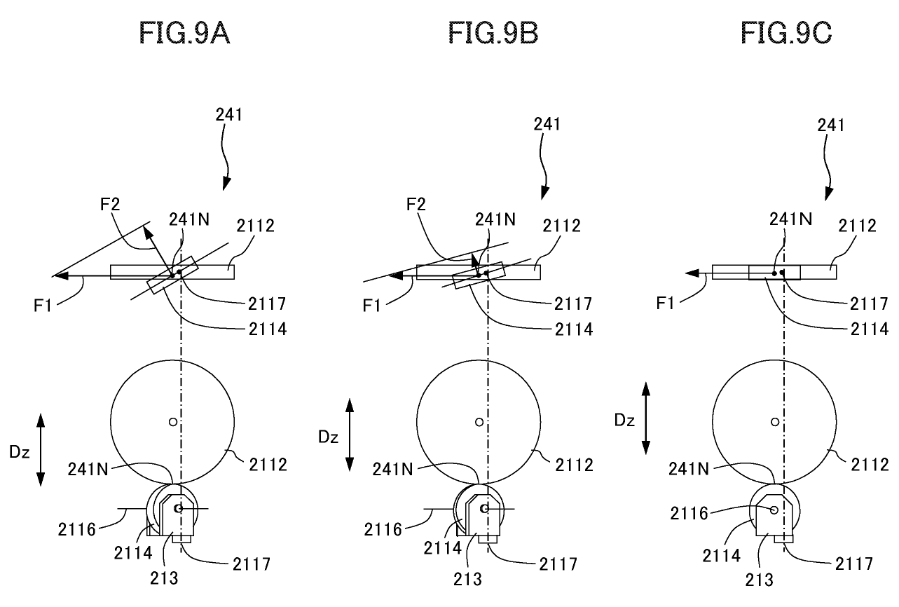

FIGS. 9A-9C are explanatory diagrams illustrating a mechanism for causing the steering direction of the driven roller to follow the steering direction of the driving roller. In FIGS. 9A-9C, the upper diagrams are plan views, and the lower views are side views. The principle in which the steering direction of the driven roller follows that of the driving roller by driving the driving roller will be described. Here, the left roller pair 241 will be described, but the same applies to the right roller pair 242.

FIG. 9A is an explanatory view illustrating a state in which the steering directions of the left driving roller 2112 and the left driven roller 2114 do not align with each other. The steering direction of the left driven roller 2114 turns around the second turning shaft 2117. Since the left driving roller 2112 and the left driven roller 2114 are in the contact state, the left driven roller 2114 receives a rotational force from the left driving roller 2112 via the nip portion 241N. When the left driving motor 2101 drives the left driving roller 2112, a force F1 pulling the nip portion 241N in a tangential direction of the left driving roller 2112 is generated in the left driven roller 2114. As a result, a force F2 causing the steering direction of the left driven roller 2114 to follow that of the left driving roller 2112 is generated in the left driven roller 2114, so that the left driven roller 2114 begins to turn in the direction of the force F2.

FIG. 9B is a diagram illustrating the behavior of the left driven roller 2114 that is turning. The steering direction of the left driven roller 2114 that is turning gradually approaches the steering direction of the left driving roller 2112. At this time, the force F2 decreases as the steering direction of the left driven roller 2114 approaches the steering direction of the left driving roller 2112. Therefore, the steering direction of the left driven roller 2114 begins to be stable as it approaches the steering direction of the left driving roller 2112.

FIG. 9C is a diagram when the steering direction of the left driven roller 2114 aligns with the steering direction of the left driving roller 2112. The force F2 becomes zero when the steering direction of the left driven roller 2114 aligns with the steering direction of the left driving roller 2112. As a result, the steering direction of the left driven roller 2114 converges to the steering direction of the left driving roller 2112. In this manner, the steering direction of the left driven roller 2114 can be made to follow the steering direction of the left driving roller 2112.

Here, for simplicity of explanation, the steering direction of the left driven roller 2114 is described as converging to the steering direction of the left driving roller 2112 at a time. In practice, depending on the magnitude of the force F1 and the distance between the nip portion 241N and the second turning shaft 2117, the steering direction of the left driven roller 2114 may gradually converge to the left driving roller 2112 while vibrating.

### Explanation of Operation

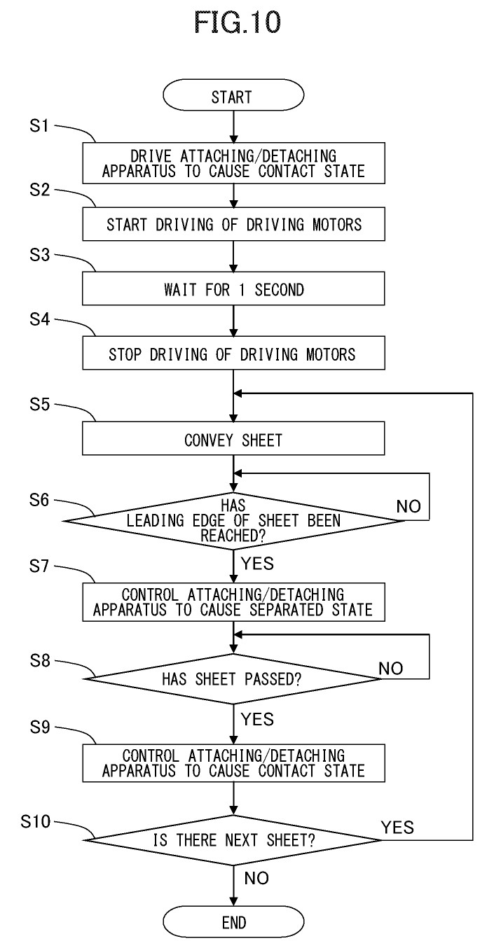

Next, a processing procedure of control for causing the steering direction of the driven roller to follow the steering direction of the driving roller will be described with reference to a flowchart illustrated in FIG. 10. This flowchart is executed when the inkjet recording system 1 starts a print job, or when a print job once interrupted due to sheet jam handling processing or the like is restarted.

The CPU 2002 drives the attaching/detaching apparatus 2120 to bring the left driving roller 2112 and the left driven roller 2114 into contact with each other and bring the right driving roller 2113 and the right driven roller 2115 into contact with each other (S1). As a result, the left roller pair 241 and the right roller pair 242 come into the contact state. The CPU 2002 starts driving of the left driving motor 2101 and the right driving motor 2102 (S2). The conveyance speed at this time is 1000 mm/s, which is higher than the conveyance speed during a printing operation (S5) to be described below. This is to shorten the time used for the steering direction of the driven roller to converge to the steering direction of the driving roller in order to shorten the preparation time until the inkjet recording system 1 starts printing and improve convenience.

Here, an operation of bringing the left roller pair 241 and the right roller pair 242 into the contact state, rotating the left driving roller 2112 and the right driving roller 2113, and turning the left driven roller 2114 and the right driven roller 2115 to follow the left driving roller 2112 and the right driving roller 2113 is defined as a first operation. In the present embodiment, the CPU 2002 executes the first operation before a leading edge of a sheet conveyed by the conveyance roller pairs 208 and 209 reaches the left roller pair 241 and the right roller pair 242.

The CPU 2002 waits for 1 second to elapse as a predetermined time in a state where the left driving motor 2101 and the right driving motor 2102 are driven (S3). Here, 1 second is set as the predetermined time, but the predetermined time is not limited thereto. That is, the predetermined time may be set to be shorter or longer than 1 second as long as it is sufficient to ensure convergence of the steering direction even when the steering directions of the driven roller and the driving roller deviate from each other by a maximum angle. However, for example, when the predetermined time is shorter than 0.1 seconds, convergence to the steering direction cannot be achieved, and when the predetermined time is longer than 1 second, the start of printing is delayed. Therefore, the predetermined time may be in the range of 0.1 seconds to 1 second. That is, the CPU 2002 executes the first operation for the predetermined time before the leading edge of the sheet reaches the left roller pair 241 and the right roller pair 242.

The CPU 2002 stops the driving of the left driving motor 2101 and the right driving motor 2102 (S4). That is, after the execution of the first operation, the CPU 2002 stops the driving of the left driving roller 2112 and the right driving roller 2113 in the contact state before the leading edge of the sheet reaches the left roller pair 241 and the right roller pair 242. In this state, the CPU 2002 stands by for conveying the sheet. Here, the driving of the left driving roller 2112 and the right driving roller 2113 is stopped, but it is not necessary to stop the driving of the left driving roller 2112 and the right driving roller 2113.

The CPU 2002 conveys the sheet toward the registration unit 210 (S5). During sheet conveyance, skew feeding correction and lateral deviation correction are performed on the sheet. The conveyance speed at this time is, for example, 675.65 mm/s.

That is, after the execution of the first operation, the CPU 2002 can execute a second operation of correcting at least one of the position and the skew feeding of the sheet while conveying the sheet using the left roller pair 241 and the right roller pair 242. A rotational speed of the left driving roller 2112 in the first operation is a first speed (corresponding to a sheet conveyance speed of 1000 mm/s), and a rotational speed of the left driving roller 2112 in the second operation is a second speed (corresponding to a sheet conveyance speed of 675.65 mm/s) lower than the first speed.

The CPU 2002 determines whether the leading edge of the sheet has reached the vacuum box 2206 (S6). This determination is made, for example, based on a detection result of a sensor (not illustrated) provided in the vicinity of the vacuum box 2206. When it is determined that the leading edge of the sheet has not reached the vacuum box 2206 (S6;NO), the CPU 2002 makes a determination again in the same manner (S6).

When it is determined that the leading edge of the sheet has reached the vacuum box 2206 (S6;YES), the CPU 2002 controls the attaching/detaching apparatus 2120. By controlling the attaching/detaching apparatus 2120, the CPU 2002 separates the left driving roller 2112 and the left driven roller 2114 from each other, and separates the right driving roller 2113 and the right driven roller 2115 from each other (S7). As a result, the left roller pair 241 and the right roller pair 242 come into the separated state.

The CPU 2002 determines whether the trailing edge of the sheet has passed through the nip portions 241N and 242N (S8). This determination is made, for example, based on detection results of the second left sheet detection sensor 2108 and the second right sheet detection sensor 2109. When it is determined that the trailing edge of the sheet has not passed through the nip portions 241N and 242N (S8;NO), the CPU 2002 makes a determination again in the same manner (S8).

When it is determined that the trailing edge of the sheet has passed through the nip portions 241N and 242N (S8;YES), the CPU 2002 controls the attaching/detaching apparatus 2120. By controlling the attaching/detaching apparatus 2120, the CPU 2002 brings the left driving roller 2112 and the left driven roller 2114 into contact with each other, and brings the right driving roller 2113 and the right driven roller 2115 into contact with each other (S9). As a result, the left roller pair 241 and the right roller pair 242 come into the contact state.

The CPU 2002 determines whether there is a next sheet (S10). When it is determined that there is a next sheet (S10;YES), the CPU 2002 conveys the sheet again (S5). When it is determined that there is no next sheet (S10;NO), the CPU 2002 ends the processing. Note that the positions of the leading edge and the trailing edge of the sheet are determined by measuring a time elapsed from the start of conveyance from the feeding module 100 and based on the sheet conveyance speed and the distance between modules, using known techniques.

As described above, according to the present embodiment, even when the steering direction of the driven roller does not align with the direction of the driving roller, control is performed such that the steering direction of the driven roller aligns with the steering direction of the driving roller before the sheet reaches the registration unit 210. As a result, skew feeding correction and lateral deviation correction can be realized with high accuracy.

According to the present disclosure, it is possible to provide a new technique related to a sheet conveyance apparatus, an image forming apparatus, and an image forming system, each including a roller pair that can be brought into a contact state and into a separated state.

### Other Embodiments

Note that, in the present embodiment described above, the registration unit 210 performs skew feeding correction upstream of the recording unit 230 serving as an image forming unit in the sheet conveyance direction Df. However, the skew feeding correction is not limited thereto, and for example, the skew feeding correction may be performed upstream of an image reading unit that reads an image on a sheet, a punching unit that punches a sheet, a folding unit that folds a sheet, or the like in the sheet conveyance direction Df. In short, the sheet conveyance apparatus that performs skew feeding correction may be any device or may be incorporated in any device.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-079448, filed May 12, 2025 which is hereby incorporated by reference herein in its entirety.

What is claimed is:

1. A sheet conveyance apparatus comprising:
a conveyance unit configured to convey a sheet in a conveyance direction;
a first roller pair disposed downstream of the conveyance unit in the conveyance direction, the first roller pair including a first driving roller configured to rotate about a first rotation shaft, and a first driven roller disposed to face the first driving roller and configured to rotate about a second rotation shaft while being driven by the first driving roller;
a switching mechanism configured to switch between a contact state in which the first driven roller and the first driving roller are brought into contact with each other, and a separated state in which the first driven roller and the first driving roller are separated from each other;
a first conveyance driving unit configured to rotate the first driving roller about the first rotation shaft;
a first turn driving unit configured to turn the first driving roller about a first turning shaft extending in an intersecting direction intersecting both the conveyance direction and a width direction of the sheet orthogonal to the conveyance direction;
a first turning support configured to support the first driven roller to be turnable about a second turning shaft extending in the intersecting direction; and
a control unit configured to start a print job, and execute a first operation of bringing the switching mechanism into the contact state and rotate the first driving roller by the first conveyance driving unit before a leading edge of the sheet conveyed by the conveyance unit reaches the first roller pair, so that the first driven roller is turned to follow the first driving roller while being driven by the first driving roller.

2. The sheet conveyance apparatus according to claim 1, wherein the control unit is configured to execute the first operation for a predetermined time before the leading edge of the sheet reaches the first roller pair.

3. The sheet conveyance apparatus according to claim 1, wherein
the control unit is configured to execute a second operation of correcting at least one of a position and skew feeding of the sheet while the sheet is being conveyed by the first roller pair after execution of the first operation,
a rotational speed of the first driving roller about the first rotation shaft in the first operation is a first speed, and
a rotational speed of the first driving roller about the first rotation shaft in the second operation is a second speed lower than the first speed.

4. The sheet conveyance apparatus according to claim 1, further comprising:
a second roller pair disposed alongside the first roller pair in the width direction, the second roller pair including a second driving roller configured to rotate about a third rotation shaft, and a second driven roller disposed to face the second driving roller and configured to rotate about a fourth rotation shaft while being driven by the second driving roller;
a second conveyance driving unit configured to rotate the second driving roller about the third rotation shaft;
a second turn driving unit configured to turn the second driving roller about a third turning shaft extending in the intersecting direction; and
a second turning support configured to support the second driven roller to be turnable about a fourth turning shaft extending in the intersecting direction,
wherein the switching mechanism brings the first driven roller and the first driving roller into contact with each other and brings the second driven roller and the second driving roller into contact with each other in the contact state, and separates the first driven roller and the first driving roller from each other and separates the second driven roller and the second driving roller from each other in the separated state.

5. The sheet conveyance apparatus according to claim 4, wherein
the fourth rotation shaft is located downstream of the fourth turning shaft in the conveyance direction, and
in the first operation, the control unit is configured to bring the switching mechanism into the contact state and rotate the second driving roller by the second conveyance driving unit, so that the second driven roller is turned to follow the second driving roller while being driven by the second driving roller.

6. The sheet conveyance apparatus according to claim 1, wherein the control unit is configured to stop the driving of the first driving roller by the first conveyance driving unit, in a state where the first driving roller and the first driven roller are brought into contact with each other, before the leading edge of the sheet reaches the first roller pair after the execution of the first operation.

7. The sheet conveyance apparatus according to claim 2, wherein the predetermined time is a time within a range of 0.1 seconds to 1 second.

8. The sheet conveyance apparatus according to claim 2, wherein the predetermined time is a time in which the first driven roller can follow the first driving roller by turning even in a case where the first driven roller deviates from the first driving roller by a maximum angle.

9. The sheet conveyance apparatus according to claim 1, wherein in a case where viewed in an axial direction of the second rotation shaft, the second rotation shaft is located downstream of the second turning shaft in the conveyance direction.

10. The sheet conveyance apparatus according to claim 3, further comprising:
a downstream conveyance unit disposed downstream of the first roller pair in the conveyance direction, and configured to convey a sheet,
wherein the control unit is configured to switch the switching mechanism to the separated state in a case where the leading edge of the sheet reaches the downstream conveyance unit after the execution of the second operation.

11. The sheet conveyance apparatus according to claim 10, wherein the control unit is configured to switch the switching mechanism to the contact state in a case where a trailing edge of the sheet passes through the first roller pair in a state where the switching mechanism has switched to the separated state.

12. An image forming apparatus comprising:
the sheet conveyance apparatus according to claim 1; and
an image forming unit configured to form an image on a sheet conveyed by the sheet conveyance apparatus.

13. An image forming system comprising:
the image forming apparatus according to claim 12; and
a processing apparatus configured to perform processing on a sheet on which an image is formed by the image forming apparatus.
